(19) United States
(12) Patent Application Publication
(10) Pub. No.: US 2012/0140921 A1
(43) Pub. Date: Jun. 7, 2012

(54) RSA-ANALOGOUS XZ-ELLIPTIC CURVE CRYPTOGRAPHY SYSTEM AND METHOD

(75) Inventors: LAHOUARI GHOUTI, DHAHRAN (SA); MOHAMMAD K. IBRAHIM, LEICESTER (GB)

(73) Assignee: KING FAHD UNIVERSITY OF PETROLEUM AND MINERALS, DHAHRAN (SA)

(21) Appl. No.: 12/958,337

(22) Filed: Dec. 1, 2010

(51) Int. Cl. H04L 9/30

(52) U.S. Cl. 380/44

(57) ABSTRACT

The RSA-analogous XZ-elliptic curve cryptography system and method provides a computerized system and method that allows for the encryption of messages through elliptic polynomial cryptography and, particularly, in a manner which is analogous to RSA cryptography but which does not require multiple private keys, as in the RSA scheme. The RSA-analogous XZ-elliptic curve cryptography method is based on the integer factorization problem. It is well known that the integer factorization problem is a computationally “difficult” or “hard” problem.

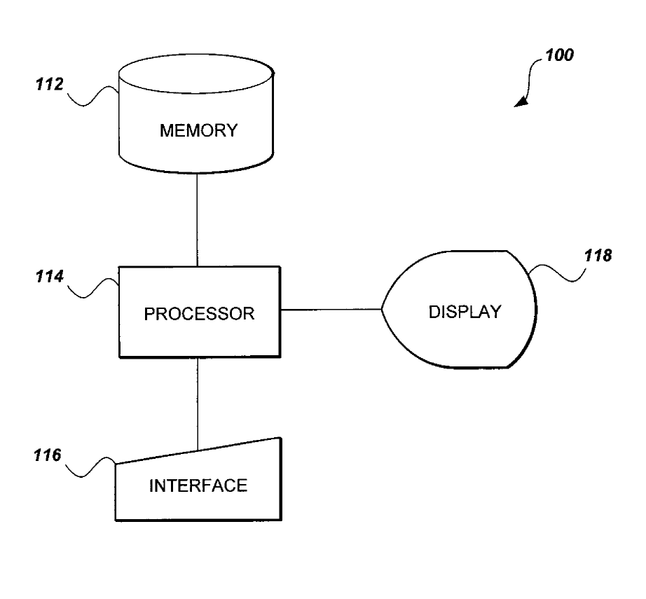

### BACKGROUND OF THE INVENTION

1. Field of the Invention

The present invention relates to computerized cryptographic systems and methods for encrypting communications in a computer network or electronic communications system, and particularly to a computerized method of performing RSA-analogous XZ-elliptic curve cryptography and cryptographic devices incorporating the method.

2. Description of the Related Art

In recent years, the Internet community has experienced explosive and exponential growth. Given the vast and increasing magnitude of this community, both in terms of the number of individual users and web sites, and the sharply reduced costs associated with electronically communicating information, such as e-mail messages and electronic files, between one user and another, as well as between any individual client computer and a web server, electronic communication, rather than more traditional postal mail, is rapidly becoming a medium of choice for communicating information. The Internet, however, is a publicly accessible network, and is thus not secure. The Internet has been, and increasingly continues to be, a target of a wide variety of attacks from various individuals and organizations intent on eavesdropping, intercepting and/or otherwise compromising or even corrupting message traffic flowing on the Internet, or further illicitly penetrating sites connected to the Internet.

Encryption by itself provides no guarantee that an enciphered message cannot or has not been compromised during transmission or storage by a third party. Encryption does not assure integrity due to the fact that an encrypted message could be intercepted and changed, even though it may be, in any instance, practically impossible, to cryptanalyze. In this regard, the third party could intercept or otherwise improperly access a ciphertext message, and then substitute a predefined illicit ciphertext block(s), which that party, or someone else acting in concert with that party, has specifically devised for a corresponding block(s) in the message. The intruding party could thereafter transmit the resulting message with the substituted ciphertext block(s) to the destination, all without the knowledge of the eventual recipient of the message.

The field of detecting altered communication is not confined to Internet messages. With the burgeoning use of stand-alone personal computers, individuals or businesses often store confidential information within the computer, with a desire to safeguard that information from illicit access and alteration by third parties. Password controlled access, which is commonly used to restrict access to a given computer and/or a specific file stored thereon, provides a certain, but rather rudimentary, form of file protection. Once password protection is circumvented, a third party can access a stored file and then change it, with the owner of the file then being completely oblivious to any such change.

Methods of adapting discrete logarithm based algorithms to the setting of elliptic polynomials are known. However, finding discrete logarithms in this kind of group is particularly difficult. Thus, elliptic polynomial-based cryptographic algorithms can be implemented using much smaller numbers than in a finite-field setting of comparable cryptographic strength. Therefore, the use of elliptic polynomial cryptography is an improvement over finite field-based public-key cryptography.

In practice, an elliptic curve group over a finite field F is formed by choosing a pair of a and b coefficients, which are elements within F. The group consists of a finite set of points P(x,y) that satisfy the elliptic curve equation:

F(x,y)=y²−x³−ax−b=0, (1)

together with a point at infinity, O. The coordinates of the point, x and y, are elements of F represented in N-bit strings. In the following, a point is either written as a capital letter (e.g., point P) or as a pair in terms of the affine coordinates; i.e. (x,y).

The elliptic curve cryptosystem relies upon the difficulty of the elliptic curve discrete logarithm problem (ECDLP) to provide its effectiveness as a cryptosystem. Using multiplicative notation, the problem can be described as: given points B and Q in the group, find a number k such that B^{k}=Q, where k is the discrete logarithm of Q to the base B. Using additive notation, the problem becomes: given two points B and Q in the group, find a number k such that kB=Q.

In an elliptic curve cryptosystem, the large integer k is kept private and is often referred to as the secret key. The point Q and the point B are made public, and are referred to as the public key. The security of the system, thus, relies upon the difficulty of deriving the secret k, knowing the public points B and Q. The main factor that determines the security strength of such a system is the size of its underlying finite field. In a real cryptographic application, the underlying field is made so large that it is computationally infeasible to determine k in a straightforward way by computing all the multiples of B until Q is found.

At the heart of elliptic curve geometric arithmetic is scalar multiplication, which computes kB by adding together k copies of the point B. Scalar multiplication is performed through a combination of point-doubling and point-addition operations. The point-addition operations add two distinct points together, and the point-doubling operations add two copies of a point together. To compute, for example, B=(2×(2×(2B)))+2B=Q, it would take three point-doublings and two point-additions.

Addition of two points on an elliptic curve is calculated as follows. When a straight line is drawn through the two points, the straight line intersects the elliptic curve at a third point. The point symmetric to this third intersecting point with respect to the x-axis is defined as a point resulting from the addition. Doubling a point on an elliptic curve is calculated as follows. When a tangent line is drawn at a point on an elliptic curve, the tangent line intersects the elliptic curve at another point. The point symmetric to this intersecting point with respect to the x-axis is defined as a point resulting from the doubling.

Table 1 illustrates the addition rules for adding two points (x₁,y₁) and (x₂,y₂), i.e., (x₃,y₃)=(x₁,y₁)+(x₂,y₂):

TABLE 1
Summary of Addition Rules: (x₃, y₃) = (x₁, y₁) + (x₂, y₂)

| | |
|---|---|
| General Equations | x₃ = m² − x₂ − x |
| | y₃ = m(x₃ − x₁) + y₁ |
| Point Addition | $m = \frac{{y}_{2} - {y}_{1}}{{x}_{2} - {x}_{1}}$ |
| Point Doubling (x₃, y₃) = 2(x₁, y₁) | $m = \frac{3 {x}_{1}^{2} - a}{2 {y}_{1}}$ |
| (x₂, y₂) = −(x₁, y₁) | (x₃, y₃) = (x₁, y₁) + (−(x₂, y₂)) = O |
| (x₂, y₂) = O | (x₃, y₃) = (x₁, y₁) + O = (x₁, y₁) |
| −(x₁, y₁) | = (x₁, −y₁) |

For elliptic curve encryption and decryption, given a message point (xₘ,yₘ), a base point (x_{B},y_{B}), and a given key, k, the cipher point (x_{C},y_{C}) is obtained using the equation (x_{C},y_{C})=(xₘ,yₘ)+k(x_{B},y_{B}).

There are two basics steps in the computation of the above equations. The first step is to find the scalar multiplication of the base point with the key, k(x_{B},y_{B}). The resulting point is then added to the message point, (xₘ,yₘ) to obtain the cipher point. At the receiver, the message point is recovered from the cipher point, which is usually transmitted along with the shared key and the base point (xₘ,yₘ)=(x_{C},y_{C})−k(x_{B},y_{B}).

As noted above, the x-coordinate, xₘ, is represented as an N-bit string. However, not all of the N-bits are used to carry information about the data of the secret message. Assuming that the number of bits of the x-coordinate, xₘ, that do not carry data is L, then the extra bits L are used to ensure that message data, when embedded into the x-coordinate, will lead to an xₘ value that satisfies the elliptic curve equation (1). Typically, if the first guess of xₘ is not on a curve, then the second or third try will be.

Thus, the number of bits used to carry the bits of the message data is (N−L). If the secret data is a K-bit string, then the number of elliptic curve points needed to encrypt the K-bit data is

$$( \frac{K}{N - L} ) .$$

It is important to note that the y-coordinate, yₘ, of the message point carries no data bits.

An attack method, referred to as power analysis, exists in which the secret information is decrypted on the basis of leaked information. An attack method in which change in voltage is measured in cryptographic processing using secret information, such as DES (Data Encryption Standard) or the like, such that the process of the cryptographic processing is obtained and the secret information is inferred on the basis of the obtained process, is known.

As one of the measures against power analysis attack on elliptic curve cryptosystems, a method using randomized projective coordinates, is known. This is a measure against an attack method of observing whether a specific value appears or not in scalar multiplication calculations, and inferring a scalar value from the observed result. By multiplication with a random value, the appearance of such a specific value is prevented from being inferred.

In the above-described elliptic curve cryptosystem, attack by power analysis, such as DPA or the like, was not taken into consideration. Therefore, in order to relieve an attack by power analysis, extra calculation has to be carried out using secret information in order to weaken the dependence of the process of the cryptographic processing and the secret information on each other. Thus, time required for the cryptographic processing increases so that cryptographic processing efficiency is lowered.

With the development of information communication networks, cryptographic techniques have been indispensable elements for the concealment or authentication of electronic information. Efficiency in terms of computation time is a necessary consideration, along with the security of the cryptographic techniques. The elliptic curve discrete logarithm problem is so difficult that elliptic curve cryptosystems can make key lengths shorter than that in Rivest-Shamir-Adleman (RSA) cryptosystems, basing their security on the difficulty of factorization into prime factors. Thus, elliptic curve cryptosystems offer comparatively high-speed cryptographic processing with optimal security. However, the processing speed is not always high enough to satisfy smart cards, for example, which have restricted throughput or servers that have to carry out large volumes of cryptographic processing.

The pair of equations for m in Table 1 are referred to as “slope equations”. Computation of a slope equation in finite fields requires one finite field division. Alternatively, the slope computation can be computed using one finite field inversion and one finite field multiplication. Finite field division and finite field inversion are costly in terms of computational time because they require extensive CPU cycles for the manipulation of two elements of a finite field with a large order. Presently, it is commonly accepted that a point-doubling and a point-addition operation each require one inversion, two multiplications, a square, and several additions. At present, there are techniques to compute finite field division and finite field inversion and techniques to trade time-intensive inversions for multiplications through performance of the operations in projective coordinates.

In cases where field inversions are significantly more time intensive than multiplication, it is efficient to utilize projective coordinates. An elliptic curve projective point (X,Y,Z) in conventional projective (or homogeneous) coordinates satisfies the homogeneous Weierstrass equation:

\tilde{F}(X,Y,Z)=Y²Z−X³−aXZ²−bZ³=0, (2)

and, when Z≠0, it corresponds to the affine point

$$( x , y ) = ( \frac{X}{Z} , \frac{Y}{Z} ) .$$

Other projective representations lead to more efficient implementations of the group operation, such as the Jacobian representations, where the triplets (X,Y,Z) correspond to the affine coordinates

$$( x , y ) = ( \frac{X}{{Z}^{2}} , \frac{Y}{{Z}^{3}} )$$

whenever Z≠0. This is equivalent to using a Jacobian elliptic curve equation that is of the form:

\tilde{F}_{J}(X,Y,Z)=Y²−X³−aXZ⁴−bZ⁶=0. (3)

Another commonly used projection is the Chudnovsky-Jacobian coordinate projection. In general terms, the relationship between the affine coordinates and the projection coordinates can be written as

$$( x , y ) = ( \frac{X}{{Z}^{i}} , \frac{Y}{{Z}^{j}} )$$

where the values of i and j depend on the choice of the projective coordinates. For example, for homogeneous coordinates, i=1 and j=1.

It is important to note that the group addition rules are defined in the affine coordinates and not in any of the projective coordinates, i.e.,

$$( \frac{{X}_{3}}{{Z}_{3}^{i}} , \frac{{Y}_{3}}{{Z}_{3}^{j}} ) = ( \frac{{X}_{1}}{{Z}_{1}^{i}} , \frac{{Y}_{1}}{{Z}_{1}^{j}} ) + ( \frac{{X}_{2}}{{Z}_{2}^{i}} , \frac{{Y}_{2}}{{Z}_{2}^{j}} ) .$$

In other words, the computation of the coordinate values of X₃, Y₃ and Z₃ are based on the equations in Table 1, where the value of Z₃ is chosen from the denominator of the equations in Table 1 in order to remove the division operations from the calculations of X₃ and Y₃.

This implies that the points

$$( \frac{{X}_{1}}{{Z}_{1}^{i}} , \frac{{Y}_{1}}{{Z}_{1}^{j}} ) , ( \frac{{X}_{2}}{{Z}_{2}^{i}} , \frac{{Y}_{2}}{{Z}_{2}^{j}} ) and ( \frac{{X}_{3}}{{Z}_{3}^{i}} , - \frac{{Y}_{3}}{{Z}_{3}^{j}} )$$

lie on the same straight line, while (X₁,Y₁,Z₁), (X₂,Y₂,Z₂) and (X₃,−Y₃,Z₃) do not lie on the same line. Thus, one cannot write (X₃,Y₃,Z₃)=(X₁,Y₁,Z₁)+(X₂,Y₂,Z₂) when the addition operation is defined over the affine coordinate. It should be noted that defining the elliptic curve points as a group over addition is necessary so that the equation given above can be re-written as

$$( \frac{{X}_{2}}{{Z}_{2}^{i}} , \frac{{Y}_{2}}{{Z}_{2}^{j}} ) = ( \frac{{X}_{3}}{{Z}_{3}^{i}} , \frac{{Y}_{3}}{{Z}_{3}^{j}} ) - ( \frac{{X}_{1}}{{Z}_{1}^{j}} , \frac{{Y}_{1}}{{Z}_{1}^{j}} ) .$$

It is this group definition that leads to the fact that decryption, as described above, is, in fact, the reciprocal of encryption. The use of projective coordinates circumvents the need for division in the computation of each point addition and each point doubling during the calculation of scalar multiplication. Thus, integer modular division can be avoided in the calculation of a scalar multiplication, such as

$$k ( \frac{{X}_{B}}{{Z}_{B}^{i}} , \frac{{Y}_{B}}{{Z}_{B}^{j}} ) ,$$

when using projective coordinates.

The last addition for the computation of the cipher point

$$( \frac{{X}_{C}}{{Z}_{C}^{i}} , \frac{{Y}_{C}}{{Z}_{C}^{j}} )$$

(i.e., the addition of the two points

$$( \frac{{X}_{m}}{{Z}_{m}^{i}} , \frac{{Y}_{m}}{{Z}_{m}^{j}} ) and k ( \frac{{X}_{B}}{{Z}_{B}^{i}} , \frac{{Y}_{B}}{{Z}_{B}^{j}} ) )$$

can also be carried out in the chosen projection coordinate. In other words,

$$( \frac{{X}_{C}}{{Z}_{C}^{i}} , \frac{{Y}_{C}}{{Z}_{C}^{j}} ) = ( \frac{{X}_{m}}{{Z}_{m}^{i}} , \frac{{Y}_{m 1}}{{Z}_{m}^{j}} ) + ( \frac{{X}_{B}}{{Z}_{B}^{i}} , \frac{{Y}_{B}}{{Z}_{B}^{j}} ) .$$

It should be noted that Zₘ=1.

However, in the above, one division (or one inversion and one multiplication) must still be carried out to calculate

$${x}_{C} = \frac{{X}_{C}}{{Z}_{C}^{i}} ,$$

since only the affine x-coordinate of the cipher point x_{C} is sent by the sender.

The use of projective coordinates circumvents the need for division in the computation of each point addition and point doubling during the calculation of scalar multiplication. Thus, finite field division can be avoided in the calculation of a scalar multiplication, such as

$$k ( \frac{{X}_{B}}{{Z}_{B}^{i}} , \frac{{Y}_{B}}{{Z}_{B}^{j}} ) ,$$

when using projective coordinates.

The last addition for the computation of the cipher point

$$( \frac{{X}_{C}}{{Z}_{C}^{i}} , \frac{{Y}_{C}}{{Z}_{C}^{j}} )$$

(i.e., the addition of the two points

$$( \frac{{X}_{m}}{{Z}_{m}^{i}} , \frac{{Y}_{m}}{{Z}_{m}^{j}} ) and k ( \frac{{X}_{B}}{{Z}_{B}^{i}} , \frac{{Y}_{B}}{{Z}_{B}^{j}} ) )$$

can also be carried out in the chosen projection coordinate. In other words,

$$( \frac{{X}_{C}}{{Z}_{C}^{i}} , \frac{{Y}_{C}}{{Z}_{C}^{j}} ) = ( \frac{{X}_{m}}{{Z}_{m}^{i}} , \frac{{Y}_{m 1}}{{Z}_{m}^{j}} ) + ( \frac{{X}_{B}}{{Z}_{B}^{i}} , \frac{{Y}_{B}}{{Z}_{B}^{j}} ) .$$

It should be noted that Zₘ=1.

However, one division (or one inversion and one multiplication) must still be carried out in order to calculate

$${x}_{C} = \frac{{X}_{C}}{{Z}_{C}^{i}} ,$$

since only the affine x-coordinate of the cipher point, x_{C}, is sent by the sender. The use of projective coordinates circumvents the need for division in the computation of each point addition and point doubling during the calculation of scalar multiplication. Thus, finite field division can be avoided in the calculation of a scalar multiplication, such as

$$k ( \frac{{X}_{B}}{{Z}_{B}^{i}} , \frac{{Y}_{B}}{{Z}_{B}^{j}} ) ,$$

when using projective coordinates.

Thus, the encryption of (N−L) bits of the secret message using elliptic curve encryption requires at least one division when using projective coordinates. Similarly, the decryption of a single message encrypted using elliptic curve cryptography also requires at least one division when using projective coordinates.

An initial attempt at RSA-analogous elliptic curve cryptography was introduced by Koyama, Maurer, Okamoto and Vanstone (KMOV). In the KMOV scheme, Eₚ(a,b) represents the curve of y²=x³+ax+b over a finite field p. In this scheme, the value of a in the curve y²=x³+ax+b is always zero. The KMOV methodology is summarized by the following steps.

The receiving correspondent generates its public key by: (a) choosing two large prime numbers p and q such that p=q=2 mod 3 (this condition is established because when p is a prime and p=2 mod 3, for 0<b<p, then Eₚ(0,b) is a cyclic group of order #Eₚ(0,b)=p+1); (b) computing n=pq and Nₙ=lcm(p+1,q+1); (c) choosing an integer e as the public key, such that gcd(e,Nₙ)=1; and (d) computing the private key d by solving the equation ed=1 mod Nₙ. At this point, the receiving correspondent has secret keys d and Nₙ and also public keys n and e;

Encryption is performed by the sending correspondent by: (e) embedding a secret message to be encrypted into an elliptic curve message point (xₘ,yₘ); (f) computing multiplication of the scalar e with the message point (xₘ,yₘ) to obtain the cipher point (x_{c},y_{c}) as (x_{c},y_{c})=e(xₘ,yₘ); and (g) sending the x-coordinate of the cipher point (x_{c},y_{c}) to the receiving correspondent;

Decryption is then performed by the receiving correspondent by: (h) determining the value of b from x_{c} and y_{c} used in the process of encryption (it should be noted that the value of b does not change); (i) multiplying the scalar d with the cipher point (x_{c},y_{c}) to obtain the message point (xₘ,yₘ) as (xₘ,yₘ)=d(x_{c},y_{c}); and (j) recovering the message data bit string from the message point (xₘ,yₘ).

It should be noted that the KMOV scheme can be broken if an eavesdropper knows the order of the elliptic curves used instead of knowing the prime factors of the used prime numbers. Effectively, the attacker can easily obtain d by knowing e and Nₙ. The difficulty of the problem of obtaining the order of elliptic curve modulo n has not conclusively been proven to be as hard as the difficulty of factoring the composite. In the above, “lcm” represents the least common multiple and “gcd” represents the greatest common denominator operations.

A more advanced RSA-analogous elliptic curve cryptography method was later introduced by Demytko. In the Demytko scheme, Eₚ(a,b) represents the curve of y²=x³+ax+b over finite field p, while Ēₚ(a,b) represents the twist of the same curve. It should be noted that it is well know that #Eₚ(a,b)=p+1+α, where |α|<2\sqrt{p} and #Ēₚ(a,b)=p+1−α, where # denotes the order of the group.

The Demytko scheme includes the following steps. The receiving correspondent generates its public key by: (a) choosing two large prime numbers p and q and two values gᵤ and gᵥ, where gᵤ is the non-residue of p and gᵥ is the non-residue of q; (b) choosing a and b such that gcd(4a³+27b²,pq)=1; (c) computing the following values:

N₁, which is the order of y²=x³+aX+b over finite field F(p),

N₂, which is the order of gᵤy²=x³+ax+b over finite field F(p),

N₃, which is the order of y²=x³+aX+b over finite field F(q), and

N₄, which is the order of gᵥy²=x³+ax+b over finite field F(q)

(it should be noted that one only needs the values of N₁ and N₃, from which values of N₂ and N₄ can be obtained); (d) choosing an integer e such that gcd(e,N₁)=gcd(e,N₂)=gcd(e,N₃)=gcd(e,N₄)=1; and (e) obtaining dᵢ for i=1, . . . , 4 by solving the following equations:

ed₁=1 mod lcm(N₁,N₃)

ed₂=1 mod lcm(N₁,N₄)

ed₃=1 mod lcm(N₂,N₃) and

ed₄=1 mod lcm(N₂,N₄)

where the receiving correspondent has a public key (n,e,a,b) and has four private keys dᵢ for i=1, . . . , 4, where n=pq.

Encryption is performed by the sending correspondent by: (f) embedding the message data string to be encrypted into the elliptic curve message point (xₘ,yₘ); (g) computing multiplication of the scalar e with the message point (xₘ,yₘ) to obtain the cipher point (x_{c},y_{c}) as (x_{c},y_{c})=e(xₘ,yₘ); and (h) sending the x-coordinate of the cipher point (x_{c},y_{c}) to the receiving correspondent;

Decryption is then performed by the receiving correspondent by: (i) after receiving the cipher point message, computing w=x_{c}³+ax_{c}+b and selecting i based on the following rules:

$$i = 1 if ( \frac{w}{p} ) = 1 and ( \frac{w}{q} ) = 1 ;$$

$$i = 2 if ( \frac{w}{p} ) = 1 and ( \frac{w}{q} ) = - 1 ;$$

$$i = 3 if ( \frac{w}{p} ) = - 1 and ( \frac{w}{q} ) = 1 ; and$$

$$i = 4 if ( \frac{w}{p} ) = - 1 and ( \frac{w}{q} ) = - 1 ,$$

where

$$( \frac{d}{p} )$$

denotes the Legendre symbol; (j) according to the selection of i, computing a scalar multiplication by multiplying the scalar dᵢ with the cipher point (x_{c},y_{c}) to obtain the message point (xₘ,yₘ) as (xₘ,yₘ)=dᵢ(x_{c},y_{c}); and (k) recovering the message data string from the message point (xₘ,yₘ).

It can be easily shown that the KMOV scheme is a special case of the Demytko scheme with a=0 and with b computed in the ciphertext. Letting Nᵢ=lcm(p+1,q+1) leads directly to the Demytko scheme. In the above, the Legendre symbol is used. The Legendre symbol is generally used to test whether an element of F(p) has a square root or not, i.e., whether an element is quadratic residue or not. The Legendre Symbol and test are as follows. Given an element d of a finite field F(p), the Legendre symbol is defined as

$$( \frac{d}{p} ) .$$

In order to test whether d is quadratic residue or not, the Legendre symbol,

$$( \frac{d}{p} ) ,$$

is computed such that:

$$( \frac{d}{p} ) = \{ \begin{matrix}+ 1 & if x is quadratic residue \\ 0 & if x ≡ 0 mod F ( p ) \\ - 1 & otherwise .\end{matrix}$$

The two top candidate computationally “hard” problems that have been examined most extensively to date for public key cryptography are the discrete logarithm problem and the integer factorization problem. Rivest-Shamir-Adleman (RSA) public key cryptography is based on the integer factorization problem.

For elliptic curve cryptography, the discrete logarithm problem has generally been the problem of choice. Comparing RSA cryptosystems and elliptic curve cryptosystems, the former requires a larger word length to achieve the same level of security as an elliptic curve cryptosystem. For example, it has been reported that the level of security that is achieved with a word length of 2,048 bits in RSA is equivalent to the level of security that can be achieved with 192 bits in elliptic curve cryptosystems. However, it has also been reported that verification of RSA digital signatures is more efficient than elliptic curve digital signature verification, despite the larger word length. RSA digital signature verification is, therefore, more appropriate for low-power portable devices.

Elliptic curve cryptography based on the discrete logarithm problem has been shown to have many advantages due to its ability to provide the same level of security as RSA while using shorter keys. Its primary disadvantage appears to be its lack of maturity, as mathematicians generally believe that enough research has not yet been performed on the elliptic curve discrete logarithm problem.

The primary advantage of RSA public key cryptosystems over elliptic curve cryptosystems based on the discrete logarithm problem is that only the receiving correspondent needs to have a public key. In other words, a secure communication can take place even if the sending correspondent does not have a public key. Such one-sided public key encryption is advantageous for channel setup and key management.

Elliptic curve cryptography based on the integer factorization problem has not received much interest to date. The most obvious reason for this is that prior known elliptic curve cryptosystems based on integer factorization essentially give no practical advantage over RSA, since both RSA cryptosystems and RSA-analogous elliptic curve cryptosystems are based on an identical factorization problem. In other words, the two systems offer the same level of security for the same pair of prime numbers and for the same group/field orders.

Thus, an RSA-analogous XZ-elliptic curve cryptography system and method solving the aforementioned problems is desired.

### SUMMARY OF THE INVENTION

The RSA-analogous XZ-elliptic curve cryptography system and method provides for improved secure communication over an insecure channel using elliptic curve cryptography. The method uses two stages of coordinate projections. In the first of the two stages, a projective coordinate is used to embed extra message data bits in the Z-coordinate as well as the X-coordinate. In the second stage, a projective coordinate is used to remove a division operation at each iteration (and also for randomizing the computation) in order to provide a countermeasure against differential power analysis.

The method of performing RSA-analogous XZ-elliptic curve cryptography is based upon the Demytko scheme. In the following, Eₚ(a,b) represents the curve of Y²=X³+aXZ²+bZ³ over finite field F(p), and Ēₚ(a,b) represents the twist of the same curve. From the above corollary, #Eₚ(a,b)=#Ēₚ(a,b), where # denotes the order of the group. The method of performing RSA-analogous XZ-elliptic curve cryptography includes the following steps.

The receiving correspondent generates its public key by: (a) choosing two substantially large prime numbers p and q and two values gᵤ and gᵥ, where gᵤ is the non-residue of p and gᵥ is the non-residue of q; (b) choosing a and b such that gcd(4a³+27b²,pq)=1; (c) computing the following values:
Nₚ, which is the order of Y²=X³+aXZ²+bZ³ over the finite field F(p),
Nₜₚ, which is the order of gᵤY²=X³+aXZ²+bZ³ over the finite field F(p),
N_{q}, which is the order of Y²=X³+aXZ²+bZ³ over the finite field F(q), and
N_{tq}, which is the order of gᵥY²=X³+aXZ²+bZ³ over the finite field F(q), where Nₚ=Nₜₚ and N_{q}=N_{tq};
   (d) choosing a scalar e such that gcd(e,Nₚ)=gcd(e,N_{q})=1; (e) generating a secret key d as ed=1 mod lcm(Nₚ,N_{q}); and (f) publishing a public key (n,e,a,b).

Encryption is performed by the sending correspondent by: (g) embedding the message data string to be encrypted into an elliptic curve message point (Xₘ,Yₘ,Zₘ); (h) computing multiplication of the scalar e with the message point (Xₘ,Yₘ,Zₘ) to obtain a cipher point (X_{c},Y_{c},Z_{c}) as (X_{c},Y_{c},Z_{c})=e(Xₘ,Yₘ,Zₘ); and (i) sending the X-coordinate and the Z-coordinate of the cipher point (X_{c},Y_{c},Z_{c}) to the receiving correspondent.

Decryption is then performed by the receiving correspondent by: (j) computing multiplication of the scalar secret key d with the cipher point (X_{c},Y_{c},Z_{c}) to obtain the message point (Xₘ,Yₘ,Zₘ) as (Xₘ,Yₘ,Zₘ)=d(X_{c},Y_{c},Z_{c}); and (k) recovering the message data string from the message point (Xₘ,Yₘ,Zₘ).

It should be noted that in XZ-elliptic curve cryptography, the recovering correspondent has only one private or secret key d, while in the case of the conventional Demytko scheme, a correspondent must have four different private keys. Additionally, in XZ-elliptic curve cryptography, the condition on the public key e is less restrictive, and is simpler in that the public key must satisfy gcd(e,Nₚ)=gcd(e,N_{q})=1, compared to the conditions used in the Demytko scheme, where it must satisfy gcd(e,N₁)=gcd(e,N₂)=gcd(e,N₃)=gcd(e,N₄)=1.

It should be further noted that the number of bits that can be encrypted in RSA-analogous XZ-elliptic curve cryptography is proportional to the number of points that satisfy the elliptic curve equation Y²=X³+aXZ²+bZ³ defined over F(p,q), which is equal to lcm(Nₚ,N_{q}), which, in turn, is proportional to 4(p²−1)(q²−1)˜n². By comparison, the number of bits that can be encrypted using conventional RSA cryptosystems is proportional to n.

In XZ-elliptic curve cryptography, the number of points that satisfy an elliptic curve equation in projective coordinates defined over F(p), and which can be used in a corresponding cryptosystem, is proportional to p², rather than to p, as in a conventional elliptic curve cryptosystem. Thus, for the same underlying finite field, RSA-analogous XZ-elliptic curve cryptography can encrypt up to 2(N−1) bits, as compared to the N bits that can be encrypted in a conventional RSA cryptosystem, where N is the number of bits needed to represent the elements of the underlying field.

Additionally, RSA-analogous XZ-elliptic curve cryptography requires only one secret key, compared to the four secret keys that are required in the Demytko RSA-analogous elliptic curve cryptography scheme. At the same time, the choice of the public key in the RSA-analogous XZ-elliptic curve cryptography is more flexible than the choice of the public key in the Demytko scheme.

Unlike conventional elliptic curve cryptography based on the discrete logarithm problem, RSA-analogous XZ-elliptic curve cryptography is not weak against side channel attacks at the sending correspondent, and the sending correspondent does not require a public key of its own.

These and other features of the present invention will become readily apparent upon further review of the following specification and drawings.

### BRIEF DESCRIPTION OF THE DRAWINGS

The sole drawing FIGURE is a block diagram of a system for performing RSA-analogous XZ-elliptic curve cryptography according to the present invention.

### DETAILED DESCRIPTION OF THE PREFERRED EMBODIMENTS

The RSA-analogous XZ-elliptic curve cryptography system and method provides for improved secure communication over an insecure channel using elliptic curve cryptography. The method utilizes two stages of coordinate projections. In the first of the two stages, a projective coordinate is used to embed extra message data bits in the Z-coordinate as well as the X-coordinate. In the second stage, a projective coordinate is used to remove a division operation at each iteration (and also for randomizing the computation) in order to provide a countermeasure against differential power analysis.

By “XZ-elliptic curve cryptography”, the inventors refer to a cryptographic system invented by Mohammad K. Ibrahim and described in U.S. Pat. No. 7,379,546, issued May 27, 2008, which is hereby incorporated by reference in its entirety. Conventional elliptic curve cryptography is based on embedding data bits in the z-coordinate of an elliptic curve point only, and hence the inventors refer to conventional elliptic curve cryptography as x-coordinate embedding elliptic curve cryptography (or X-elliptic curve cryptography). The system described in the '546 patent allows embedding data in the X-coordinate and the Z-coordinate (in projective coordinates) of an elliptic curve point, and hence the name XZ-elliptic curve cryptography. The present method describes how an RSA-like protocol, which relies upon the integer factorization problem for its security, may be adapted for use with the XZ-elliptic curve cryptography system described by Ibrahim in the '546 patent.

The method begins by defining a set of elliptic curve points represented in projective coordinates as a group over addition. Given a field F(p), and defining a & b∈F(p), where the symbol ε denotes set membership, EC² is defined as the set of points (x,y) that satisfy the elliptic curve equation in affine coordinates (i.e., F(x,y)=y²−x³−ax−b=0), where x & y∈F(p), together with a point at infinity.

It is known that using the addition rules defined above for the set of points EC², the set EC² forms an abelian group over addition, denoted as (EC², +). The present method utilizes a projection (X,Y,Z), which is related to the affine coordinates as:

$$\begin{matrix}y = \frac{Y}{{Z}^{\frac{3}{2}}} & ( 4 ) \\ x = \frac{X}{Z} . & ( 5 )\end{matrix}$$

Substitution of equations (5) and (6) into the elliptic curve equation yields:

$$\tilde{F} ( X , Y , Z ) = {Z}^{3} F ( \frac{X}{Z} , \frac{Y}{{Z}^{\frac{3}{2}}} ) = {Y}^{2} - {X}^{3} - {aXZ}^{2} - {bZ}^{3} = 0. \qquad ( 6 )$$

It should be noted that if F(x,y) is non-singular (i.e., 4a²+27b³≠0), then \tilde{F}(X,Y,Z) is also non-singular. In the following, it is assumed that the elliptic curve equations are non-singular.

The set of points EC³ is defined as the triplets (X,Y,Z), where X,Y & Z∈F(p), that satisfy equation (6), along with a point at infinity (X₁,Y₁,Z₁), and excluding the point at the origin (0,0,0). It should be noted that EC³ is in projective coordinates, while EC² is in affine coordinates. The addition rules for the group (EC², +) can be adopted to define an additive binary operation, denoted as “+”, over EC³. For all (X₁,Y₁,Z₁)∈EC³ and (X₂,Y₂,Z₂)∈EC³, the sum (X₃,Y₃,Z₃)=(X₁,Y₁,Z₁)+(X₂,Y₂,Z₂) is also (X₃,Y₃,Z₃)∈EC³.

It can be seen that (EC³, +) also forms a group over addition that satisfies the following axioms: (i) There exists (X₁,Y₁,Z₁)∈EC³ such that (X,Y,Z)+(X₁,Y₁,Z₁)=(X,Y,Z) for all (X,Y,Z)∈EC(K³); (ii) for every (X,Y,Z)∈EC³, there exists −(X,Y,Z)∈EC³ such that (X,Y,Z)−(X,Y,Z)=(X₁,Y₁,Z₁); (iii) the additive binary operation is commutative; and (iv) the additive binary operation is associative.

With regard to the addition rules for the group (EC³, +), the addition of two points on an elliptic curve in projective coordinate EC³ is calculated as follows. When a straight line is drawn through two points of EC³, the straight line intersects the elliptic curve in projective coordinates at a third point. The point symmetric to this third intersecting point, with respect to the X-axis, is defined as a point resulting from the addition.

A straight-line equation in projective coordinates is given by:

$$\frac{X - {X}_{1}}{{X}_{2} - {X}_{1}} = \frac{Y - {Y}_{1}}{{Y}_{2} - {Y}_{1}} = \frac{Z - {Z}_{1}}{{Z}_{2} - {Z}_{1}} . \qquad ( 7 )$$

The basic addition rule can be formulated as follows: Draw the line that joins the two points to be added in the set EC³. Denoting the third point of intersection as (X₃′,Y₃′,Z₃′), the sum point is defined as (X₃,Y₃,Z₃)=(X₃′,−Y₃′,Z₃′). It follows from the above definition that the addition over EC³ is commutative, that is:

(X₁,Y₁,Z₁)+(X₂,Y₂,Z₂)=(X₂,Y₂,Z₂)+(X₁,Y₁,Z₁)

for all (X₁,Y₁,Z₁)∈E(K³) and (X₂,Y₂,Z₂)∈E(K³). This satisfies axiom (iii) above.

There are four main cases that need to be considered for the computation of addition for (EC³, +):
(A) X₁≠X₂;
(B) X₁=X₂ and Z₁≠Z₂;
(C) (X₁,Y₁,Z₁)=(X₂,Y₂,Z₂) (i.e., point doubling); and
(D) X₁=X₂ and Z₁=Z₂.

For case (A) where X₁≠X₂, we have:

Y₃′=Y₁+m_{y}(X₃′−X₁) (8)

and

Z₃′=Z₁+m_{z}(X₃′−X₁), (9)

where

$$\begin{matrix}{m}_{y} = \frac{{Y}_{2} - {Y}_{1}}{{X}_{2} - {X}_{1}} & ( 10 ) \\ {m}_{z} = \frac{{Z}_{2} - {Z}_{1}}{{X}_{2} - {X}_{1 }} . & ( 11 )\end{matrix}$$

Substituting equation (8) for Y₃′ and equation (9) for Z₃′ into equation (6) yields:

(Y₁+m_{y}(X−X₁))²−X³−aX(Z₁+m_{z}(X−X₁))²−b(Z₁+m_{z}(X−X₁))³=0 (12)

Expanding the terms between parentheses and grouping the terms with the same powers of X gives:

X³+am_{z}²X³+bm_{z}³X³−m_{y}²X²+2am_{z}Z₁X²−2am_{z}²X²X₁+bm_{z}²Z₁X²+2bm_{z}²Z₁X²−2bm_{z}³X²X₁−bm_{z}³X²X₁−2m_{y}Y₁X+2m_{y}²XX₁+aXZ₁²−2am_{z}Z₁XX₁+am_{z}²XX₁²+2bm_{z}Z₁²X−2XX₁bm_{z}²Z₁+bm_{z}XZ₁²−4bm_{z}²Z₁XX₁+bm_{z}³XX₁²+2bm_{z}³XX₁²−Y₁²+2m_{y}Y₁X₁−m_{y}²X₁²+bZ₁³−2bm_{z}Z₁²X₁+bX₁²m_{z}²Z₁−bm_{z}X₁Z₁²+2bm_{z}²Z₁X₁²−bm_{z}³X₁³=0. (13)

In order to solve the above, it is recognized that any cubic equation has three roots, such that

(X−X₁)(X−X₂)(X−X₃′)=0, (14)

and scaling the coefficient of the term X³ to 1 in equation (13), and equating the coefficient of the term X² in equations (13) and (14), yields:

$$\begin{matrix}{X}_{3}^{′} = \frac{1}{c} ( {m}_{y}^{2} - 2 {am}_{z} {Z}_{1} + 2 {am}_{x}^{2} {X}_{1} - 3 {bm}_{z}^{2} {Z}_{1} + 3 {bm}_{z}^{3} {X}_{1} ) - {X}_{1} - {X}_{2} & ( 15 ) \\ {X}_{3}^{′} = \frac{1}{c} ( {m}_{y}^{2} - ( 2 a + 3 {bm}_{z} ) {m}_{z} {Z}_{1} + ( 2 a + 3 {bm}_{z} ) {m}_{z}^{2} {X}_{1} ) - {X}_{1} - {X}_{2} . & ( 16 )\end{matrix}$$

or
After grouping terms to reduce the number of computations, one obtains:

$${X}_{3}^{′} = \frac{1}{c} ( {m}_{y}^{2} - {m}_{z} ( 2 a + 3 {bm}_{z} ) ( {Z}_{1} - {m}_{z} {X}_{1} ) ) - {X}_{1} - {X}_{2} , \qquad ( 17 )$$

where

c=1+am_{z}²+bm_{z}³. (18)

Substituting the solution of X₃′, which is given in equation (17), into equation (8) yields the solution for Y₃′. Similarly, substituting the solution of X₃′, which is given in equation (17), into equation (9) produces the solution for Z₃′.

For case (B), where X₁=X₂ and Z₁≠Z₂, we let Xₒ=X₁=X₂. In this case, X₃=X₁=X₂=Xₒ, since the straight line is in the YZ-plane Xₒ. Thus, one can write:

Y₃′=Y₁+n_{y}(Z₃′−Z₁), (19)

where

$${n}_{y} = \frac{{Y}_{2} - {Y}_{1}}{{Z}_{2} - {Z}_{1}} .$$

Substituting equation (19) into equation (6) (and noting that X=X₀) yields:

(Y₁+n_{y}(Z−Z₁))²−Xₒ³−aXₒZ²−bZ³=0. (20)

Expanding the terms between parentheses and grouping the terms with the same powers of Z, one obtains:

$${Z}^{3} - \frac{1}{b} ( {n}_{y}^{2} {Z}^{2} - {aX}_{o} {Z}^{2} ) + \frac{1}{b} ( 2 {n}_{y} {Y}_{1} Z - 2 {n}_{y}^{2} {ZZ}_{1} + {Y}_{1}^{2} - 2 {n}_{y} {Y}_{1} {Z}_{1} + {n}_{y}^{2} {ZZ}_{1} + {Y}_{1}^{2} - 2 {n}_{y} {Y}_{1} {Z}_{1} + {n}_{y}^{2} {Z}_{1}^{2} - {X}_{o}^{3} ) = 0. \qquad ( 21 )$$

In order to solve the above, it is recognized that any cubic equation has three roots, such that:

(Z−Z₁)(Z−Z₂)(Z−Z₃′)=0. (22)

Equating the coefficient of the term Z² in equations (21) and (22), one obtains:

$${Z}_{3}^{′} = \frac{1}{b} ( {n}_{y}^{2} - {aX}_{o} ) - {Z}_{1} - {Z}_{2} , \qquad ( 23 )$$

and substituting the solution of Z₃′ into equation (19) produces the solution for Y₃′.

For case (C), which involves point doubling, (X₁,Y₁,Z₁)=(X₂,Y₂,Z₂). Letting (Xₒ,Yₒ,Zₒ)=(X₁,Y₁,Z₁)=(X₂,Y₂,Z₂) then (X₃,Y₃,Z₃)=2(Xₒ,Yₒ,Zₒ). Doubling a point on an elliptic curve in projective coordinates can be defined in several ways. In the first case (C.1), when a tangent line in an XT-plane is drawn at a point on an elliptic curve, the tangent line intersects the elliptic curve in the projective coordinates EC³ at another point. The point symmetric to this intersecting point with respect to the X-axis is defined as a point resulting from the doubling. It should be noted that in this case, Z₃′=Zₒ.

In the second case (C.2), when a tangent line in a YZ-plane is drawn at a point on an elliptic curve, the tangent line intersects the elliptic curve in the projective coordinates EC³ at another point. The point symmetric to this intersecting point with respect to the X-axis is defined as a point resulting from the doubling. It should be noted that in this case, X₃′=Xₒ.

In a third case (C.3), some form of a combination of rules (C.1) and (C.2) may be used. The simplest combination is to perform doubling using rule (C.1) followed by another doubling using rule (C.2). Another combination involves using the gradients in (C.1) and (C.2) simultaneously.

For case (C.1), Z₃=Z₁=Z₂=Zₒ. The gradient of the tangent of the point (Xₒ,Yₒ,Zₒ) of the elliptic curve in projective coordinates in an XY-plane is given by:

$$\frac{d Y}{d X} = \frac{3 {X}_{o}^{2} + {aZ}_{o}^{2}}{2 {Y}_{o}} = {m}_{y} . \qquad ( 24 )$$

Substituting equation (24) for m_{y} in the equation for X₃′, and noting that m_{z}=0 in this case, one obtains the solution for X₃′:

X₃′=m_{y}²−X₁−X₂. (25)

One may similarly obtain the solution for Y₃′ from case (A) above.

For case (C.2), X₃=X₁=X₂=Xₒ. The gradient of the tangent of the point (Xₒ,Yₒ,Zₒ) of the elliptic curve in projective coordinates in a YZ-plane is given by:

$$\frac{d Y}{d Z} = \frac{2 {aX}_{o} {Z}_{o} + 3 {bZ}_{o}^{2}}{2 {Y}_{o}} = {n}_{y} . \qquad ( 26 )$$

Substituting equation (26) for n_{y} in equation (23), one obtains a solution for Z₃′:

$${Z}_{3}^{′} = \frac{1}{b} ( {n}_{y}^{2} - {aX}_{o} ) - {Z}_{1} - {Z}_{2} . \qquad ( 27 )$$

Similarly, substituting the solution of Z₃′ into equation (19), one obtains the solution for Y₃′.

For case (D), X₁=X₂ and Z₁=Z₂. Letting Xₒ=X₁=X₂ and Zₒ=Z₁=Z₂ allows for substitution of these values directly into equation (6), thus producing a quadratic equation for the r-coordinate:

Y²=Xₒ³+aXₒZₒ²+bZₒ³, (28)

where Yₒ represents one of the solutions. The other solution must be −Yₒ.

Therefore, a line perpendicular to the XZ-plane intersects EC³ at only two points: (X,Y,Z) and (X,−Y,Z)∈EC³. This clearly shows the symmetry of EC³ about the X-axis and the Z-axis. Furthermore, every (X,Y,Z)∈EC³ has a unique mirror image point (X,−Y,Z)∈EC³. Thus, since a line joining such pairs (X,Y,Z) and (X,−Y,Z)∈EC³ does not intersect with EC³ at a third finite point, such lines are assumed to intersect with EC³ at the point of infinity (X₁,Y₁,Z₁). This point at infinity is used to define both the inverse of a point in EC³ and the identity point. According to the addition rule defined above, one can write:

(X,Y,Z)+(X,−Y,Z)=(X₁,Y₁,Z₁), (29)

since the third point of intersection of such lines is the point at infinity. This equation therefore defines a unique inverse for any point (X,Y,Z)∈EC³,

−(X,Y,Z)=(X,−Y,Z). (30)

Thus, equation (29) can be written as:

(X,Y,Z)−(X,Y,Z)=(X₁,Y₁,Z₁). (31)

Additionally, a line joining the point at infinity and any point (X,Y,Z)∈EC³ will intersect with EC³ at (X,−Y,Z). Therefore, from the addition rule defined above, one may also write:

(X,Y,Z)+(X₁,Y₁,Z₁)=(X,Y,Z). (32)

Equation (31) satisfies axiom (ii) while equation (32) satisfies axiom (i) of the group (EC³,+).

One way of proving associativity of (EC³,+) is as follows. Given particular elliptic curves (i.e., for particular coefficient's a and b and a finite field F(p), if it can be shown by computation that any point Q∈EC³ can be uniquely written as k_{Q}P, where P is the generator point of the group (EC³,+), then EC³ groups based on such curves are associative. The reason for the above is that any three points Q,R,S∈EC³ can be written as k_{Q}P,k_{R}P,k_{S}P∈EC³, respectively. Thus, their sum (Q+R+S)=(k_{Q}P+k_{R}P+k_{S}P)=(k_{Q}+k_{R}+k_{S})P can be carried out in any order.

With regard to the second projective coordinate, each of the equations for point addition and point doubling derived for the cases (A), (B) and (C) above require one modular inversion or division. In cases where field inversions or divisions are significantly more expensive than multiplication (in terms of time and computational power), a second projective coordinate is used to remove the requirement for field inversion or division from these equations. As shown below, the number of operations needed for EC³ point doubling and point addition when performed in the second projective coordinate are comparable to those needed in EC². It should be noted that several projective coordinates can be used. In the present method, the homogenous projection is used as an example:

$$\begin{matrix}X = \frac{X}{V} & ( 33 ) \\ Y = \frac{Y}{V} & ( 34 ) \\ Z = \frac{Z}{V} . & ( 35 )\end{matrix}$$

Using this projection in the elliptic curve equation given by equation (6), one obtains a homogeneous elliptic curve equation:

$$\begin{matrix}\tilde{F} ( X , Y , Z , V ) = V \tilde{F} ( \frac{X}{V} , \frac{Y}{V} , \frac{Z}{V} ) \\ = {Y}^{2} V - {X}^{3} - {aXZ}^{2} - {bZ}^{3} \\ = 0 ,\end{matrix} \qquad ( 36 )$$

where an elliptic curve projective point (X,Y,Z,V) using homogenous-projective coordinates satisfies the homogenous elliptic curve equation (36).

When V≠0, the homogenous projected point (X,Y,Z,V) corresponds to the projected point

$$( X , Y , Z ) = ( \frac{X}{V} , \frac{Y}{V} , \frac{Z}{V} ) .$$

Using homogenous projective coordinates, the equation for point addition can be written as:

$$( \frac{{X}_{3}}{{V}_{3}} , \frac{{Y}_{3}}{{V}_{3}} , \frac{{Z}_{3}}{{V}_{3}} ) = ( \frac{{X}_{1}}{{V}_{1}} , \frac{{Y}_{1}}{{V}_{1}} , \frac{{Z}_{1}}{{V}_{1}} ) + ( \frac{{X}_{2}}{{V}_{2}} , \frac{{Y}_{2}}{{V}_{2}} , \frac{{Z}_{2}}{{V}_{2}} ) . \qquad ( 37 )$$

In the following, it is shown how the homogenous projective coordinates can be used to remove the need for modular inversion or division from the equations given above for cases (A), (B) and (C). Starting with case (A), substitution for X, Y and Z in terms of the projective coordinates in equations (33), (34) and (35) into the equation given above for X₃′, and noting that c=1+am_{z}²+bm_{z}³, yields:

$${X}_{3}^{′} = \frac{( \begin{matrix}{λ}_{yv}^{2} {λ}_{xv} - 2 a {λ}_{zv} {λ}_{xv}^{2} {Z}_{1} + 2 a {λ}_{zv}^{2} {λ}_{xv} {X}_{1} - \\ 3 b {λ}_{zv}^{2} {λ}_{xv} {Z}_{1} + 3 b {λ}_{zv}^{3} {X}_{1}\end{matrix} )}{{λ}_{xzv}} - \frac{{X}_{1}^{′}}{{V}_{1}} - \frac{{X}_{2}^{′}}{{V}_{2}} , \qquad ( 38 )$$

where

λₓᵥ=(X₂V₁−X₁V₂) (39)

λ_{yv}=(Y₂V₁−Y₁V₂) (40)

λ_{zv}=(Z₂V₁−Z₁V₂) (41)

λ_{xyv}=(λₓᵥ³+aλₓᵥλ_{zv}²+bλ_{zv}³) (42)

Letting

V₃=V₁V₂λₓᵥλ_{xzv} (43)

and substituting equation (43) for V₃ in equation (38), one obtains

X₃′=λₓᵥAₓ₃, (44)

where

Aₓ₃={λ_{yv}³λₓᵥV₂−λ_{zv}(2aλₓᵥ+3bλ_{zv})(λₓᵥZ₁V₂−λ_{zv}X₁V₂)−λ_{xzv}(V₂X₁+V₁X₂)}. (45)

Substituting for X and Y in terms of the projective coordinates in equations (33) and (34) into the equation given above for Y₃′, and following simplification, gives:

$$\frac{{Y}_{3}^{′}}{{V}_{3}} = \frac{{Y}_{1}}{{V}_{1}} + \frac{( {Y}_{2} {V}_{1} - {Y}_{1} {V}_{2} )}{( {X}_{2} {V}_{1} - {X}_{1} {V}_{2} ) {V}_{3}} ( {X}_{3}^{′} - \frac{{X}_{1} {V}_{3}}{{V}_{1}} ) . \qquad ( 46 )$$

Substituting equations (43) and (44) for V₃ and X₃′ into equation (46) produces

Y₃′=V₂λₓᵥλ_{xzv}Y₁+λ_{yv}(Aₓ₃−V₂λ_{xzv}X₁), (47)

and substituting X and Z in terms of the projective coordinates in equations (33) and (35) into the equation given above for Z₃′, and following simplification, gives:

$$\frac{{Z}_{3}^{′}}{{V}_{3}} = \frac{{Z}_{1}}{{V}_{1}} + \frac{( {Z}_{2} {V}_{1} - {Z}_{1} {V}_{2} )}{( {X}_{2} {V}_{1} - {X}_{1} {V}_{2} ) {V}_{3}} ( {X}_{3}^{′} - \frac{{X}_{1} {V}_{3}}{{V}_{1}} ) . \qquad ( 48 )$$

Substituting equations (43) and (44) for V₃ and X₃′ into equation (48) produces

Z₃′=V₂λₓᵥλ_{xzv}Z₁+λ_{zv}(Aₓ₃−V₂λ_{xzv}X₁). (49)

The number of field operations needed in equations (44), (47) and (49) are 24 multiplications, three squaring operations, and ten addition operations. When using mixed coordinates, the number of multiplications can be reduced to twenty multiplications.

For case (B), substituting X, Y and Z in terms of the heterogeneous projective coordinate into the equation given above for Z₃′, and noting that X₃=X₁=X₂=Xₒ, one obtains:

$$\frac{{Z}_{3}^{′}}{{V}_{3}} = \frac{1}{b} \frac{{( {Y}_{2} {V}_{1} - {Y}_{1} {V}_{2} )}^{2}}{{V}_{1} {{V}_{2} ( {Z}_{2} {V}_{1} - {Z}_{1} {V}_{2} )}^{2}} - \frac{a}{b} \frac{{X}_{1}}{{V}_{1}} - \frac{{Z}_{1}}{{V}_{1}} - \frac{{Z}_{2}}{{V}_{2}} , \qquad ( 50 )$$

and letting

V₃=V₁²V₂²(Z₂V₁−Z₁V₂)³, (51)

allows for the substitution of equation (51) for V₃ into equation (50), yielding:

$${Z}_{3}^{′} = \frac{1}{b} {V}_{1} {V}_{2} ( {Z}_{2} {V}_{1} - {Z}_{1} {V}_{2} ) {A}_{3 x} , \qquad ( 52 )$$

where

A₃ₓ={(Y₂V₁−Y₁V₂)²−(Z₂V₁²−Z₁V₂²)²(a/bX₁V₂+Z₁V₂+Z₂V₁)}. (53)

Substituting Y and Z in terms of the projective coordinates in equations (40) and (41) into the equation for Y₃′ produces:

$$\frac{{Y}_{3}^{′}}{{V}_{3}} = \frac{{Y}_{1}}{{V}_{1}} + \frac{( {Y}_{2} {V}_{1} - {Y}_{1} {V}_{2} )}{{V}_{3}} \times ( \frac{{Z}_{3}^{′}}{{V}_{1} {V}_{2} ( {Z}_{2} {V}_{1} - {Z}_{1} {V}_{2} )} - \frac{{Z}_{1} {V}_{3}}{{V}_{1} {V}_{2} ( {Z}_{2} {V}_{1} - {Z}_{1} {V}_{2} ) {V}_{1}} ) , \qquad ( 54 )$$

and substituting equations (51) and (52) for V₃ and Z₃′ into equation (54) gives

$${Y}_{3}^{′} = {V}_{1} {{V}_{2}^{2} ( {Z}_{2} {V}_{1} - {Z}_{1} {V}_{2} )}^{3} {Y}_{1} + ( {Y}_{2} {V}_{1} - {Y}_{1} {V}_{2} ) ( \frac{1}{b} {A}_{3 x} - {Z}_{1} {{V}_{2} ( {Z}_{2} {V}_{1} - {Z}_{1} {V}_{2} )}^{2} ) . \qquad ( 55 )$$

The number of field operations needed in equations (52) and (55) are sixteen multiplication operations, two squaring operations, and seven addition operations.

For case (C.1), substituting X, Y and Z in terms of the projective coordinates in equations (39), (40) and (41) into the equation for X₃′ produces

$$\frac{{X}_{3}^{′}}{{V}_{3}} = \frac{{( 3 {X}_{o}^{2} + {aZ}_{o}^{2} )}^{2}}{4 {V}_{o}^{2} {Y}_{o}^{2}} - 2 \frac{{X}_{o}}{{V}_{o}} , \qquad ( 56 )$$

and letting

V₃=8Vₒ³Yₒ³ (57)

allows for the substitution of equation (57) into equation (56), yielding:

X₃′=2VₒYₒD₃ₓ, (58)

where

D₃ₓ={(3Xₒ²+aZₒ²)²−8VₒYₒ²Xₒ}. (59)

Substituting X, Y and Z in terms of the projective coordinates in equations in equations (39), (40) and (41) into the equation for Y₃′, and using the gradient, produces

$$\frac{{Y}_{3}^{′}}{{V}_{3}} = \frac{{Y}_{o}}{{V}_{o}} + \frac{3 {X}_{o}^{2} + {aZ}_{o}^{2}}{{V}_{3}} ( \frac{2 {V}_{o} {Y}_{o} {D}_{3 x}}{2 {V}_{o} {Y}_{o}} - \frac{{X}_{o} {V}_{3}}{2 {V}_{o} {Y}_{o} {V}_{o}} ) , \qquad ( 60 )$$

and substituting equations (57), (58) and (59) for V₃, X₃′ and D₃ₓ gives:

Y₃′=8Vₒ²Yₒ⁴+3Xₒ²+aZₒ²((3Xₒ²+aZₒ²)²−12VₒYₒ²Xₒ). (61)

The number of field operations needed in equations (58) and (61) are six multiplication operations, four squaring operations, and five addition operations.

For case (C.1), substituting X, Y and Z in terms of the projective coordinates in equations (39), (40) and (41) into the equation for Z₃′ produces

$$\frac{{Z}_{3}^{′}}{{V}_{3}} = \frac{1}{b} \frac{{( 2 {aX}_{o} {Z}_{o} + 3 {bZ}_{o}^{2} )}^{2}}{4 {Y}_{o}^{2} {V}_{o}^{2}} - \frac{a}{b} \frac{{X}_{o}}{{V}_{o}} - 2 \frac{{Z}_{o}}{{V}_{o}} \qquad ( 62 )$$

and letting

V₃=8Vₒ³Yₒ³ (63)

allows for the substitution of equation (63) into equation (62), yielding:

Z₃′=2VₒYₒD_{3z}, (64)

where

$${D}_{3 z} = \{ \frac{1}{b} {( 2 {aX}_{o} {Z}_{o} + 3 {bZ}_{o}^{2} )}^{2} - 4 \frac{a}{b} {V}_{o} {Y}_{o}^{2} {X}_{o} - 16 {V}_{o} {Y}_{o}^{2} {Z}_{o} \} , \qquad ( 65 )$$

and substituting X, Y and Z in terms of the projective coordinate in equations (39), (40) and (41) into the equation for Y₃′, and using the gradient, gives:

$$\frac{{Y}_{3}^{′}}{{V}_{3}} = \frac{{Y}_{0}}{{V}_{o}} + \frac{2 {aX}_{o} {Z}_{o} + 3 {bZ}_{o}^{2}}{2 {V}_{o} {Y}_{o}} ( \frac{{Z}_{3}^{′}}{{V}_{3}} - \frac{{Z}_{o}}{{V}_{o}} ) . \qquad ( 66 )$$

Substituting equations (63) and (64) for V₃ and Z₃′ into equation (66) produces

Y₃′=8Vₒ²Yₒ³Yₒ+(2aXₒZₒ+3bZₒ²)(D_{3z}−4VₒYₒ²Zₒ). (67)

The number of field operations needed in equations (64) and (67) are ten multiplication operations, three squaring operations, and five addition operations.

The twist of an elliptic curve is defined as follows. Given a particular elliptic curve equation in projective coordinates defined over a finite field F(p), Y²=X³+aXZ²+bZ³, and given certain values for the X-coordinate and Z-coordinate X₀ and Z₀; respectively, that are elements of the finite field F(p), then substituting these values in the elliptic curve equation in projective coordinates, one obtains a quadratic equation in Y: Y²=Xₒ³+aXₒZₒ²+bZₒ³=T.

If the solutions of the above quadratic equation (i.e., Y²=T) are elements of the finite field F(p), then the point (Xₒ,Y,Zₒ) is said to satisfy the given elliptic curve equation. If solutions of the above quadratic equation are not elements of the finite field F(p), then the point (Xₒ,Y,Zₒ) is said to satisfy the twist of the given elliptic curve equation.

An elliptic polynomial equation of the form given above is isomorphic to its twist if: (1) there are mathematical mappings that can be defined on the values of X and Z (i.e., φ_{X}(X), φ_{Y}(Y) and φ_{Z}(Z)) such that any point (X,Y,Z) that satisfies such an elliptic polynomial equation can be mapped into another point (φ_{X}(X),φ_{Y}(Y),φ_{Z}(Z)) that satisfies the twist of the same elliptic polynomial equation; and (2) the mapping between the points (X,Y,Z) and (φ_{X}(X),φ_{Y}(Y),φ_{Z}(Z)) is unique, i.e., a one-to-one correspondence.

The proof of this theorem is as follows. Letting the right-hand side of Y²=X³+aXZ²+bZ³ be denoted as T, then T=X³+aXZ²+bZ³, where X,Z,T,a & b∈F(p). Thus, any value of X and Z will lead to a value of T∈F(p). T could be quadratic residue or non-quadratic residue. If T is quadratic residue, then the above is written as:

T_{q}=X_{q}³+aX_{q}Z_{q}²+bZ_{q}³, (68)

where X_{q} & Z_{q}∈F(p) denotes the values of X and Z that result in a quadratic residue value of T, which is hereafter denoted as T_{q}.

If T is non-quadratic residue, then the above is written as:

T _{q̅}=X _{q̅}³+aX _{q̅}Z _{q̅}²+bZ _{q̅}³, (69)

where X _{q̅} & Z _{q̅}∈F(p) denotes the values of X and Z that result in a non-quadratic residue value of T, denoted as T _{q̅}.

Letting g be any non-quadratic residue number in F(p) (i.e., g∈F(p) & \sqrt{g}∉F(p)), then multiplying the above equation for T with g³ yields:

g³T_{q}=g³X_{q}³+ag³X_{q}Z_{q}²+bg³Z_{q}³, (70)

which can be re-written as:

g³T_{q}=(gX_{q})³+a(gX_{q})(gZ_{q})²+b(gZ_{q})³. (71)

It should be noted that if g is non-quadratic residue, then g³ is also non-quadratic residue. Further, the result of multiplying a quadratic residue number by a non-quadratic residue number is a non-quadratic residue number. Thus, g*T_{q} is non-quadratic residue.

By comparing the above equations for T _{q̅} and g³T_{q}, we obtain the following mappings:

X _{q̅}=gX_{q}; (72)

Z _{q̅}=gZ_{q}; and (73)

T _{q̅}=g³T_{q}. (74)

The mappings between the variables X_{q} and X _{q̅}; Z_{q} and Z _{q̅}; and T_{q} and T _{q̅} are all bijective, i.e., there is a one-to-one correspondence from basic finite field arithmetic. As a consequence, the mappings between the three-tuple (X_{q},T_{q},Z_{q}) and the three-tuple (X _{q̅},T _{q̅},Z _{q̅}) are also bijective.

Therefore, for every solution of T_{q}=X_{q}³+aX_{q}Z_{q}²+bZ_{q}³, there is an isomorphic solution that satisfies T _{q̅}=X _{q̅}³+aX _{q̅}Z _{q̅}²+bZ _{q̅}³, and since the mappings of the coordinates of one to the other are given in the equations above, these two solutions are isomorphic with respect to each other.

Since T_{q} is quadratic residue, this expression can be written as:

T_{q}=Y². (75)

Thus, T _{q̅} can be written as:

T _{q̅}=g³Y². (76)

Using the above, T_{q}=X_{q}³+aX_{q}Z_{q}²+bZ_{q}³ and T _{q̅}=X _{q̅}³+aX _{q̅}Z _{q̅}²+bZ _{q̅}³ can be written as:

Y²=X_{q}³+aX_{q}Z_{q}²+bZ_{q}³; and (77)

g³Y²=X _{q̅}³+aX _{q̅}Z _{q̅}²+bZ _{q̅}³. (78)

Since any solution of T_{q}=X_{q}³+aX_{q}Z_{q}²+bZ_{q}³ has an isomorphic solution that satisfies T _{q̅}=X _{q̅}³+aX _{q̅}Z _{q̅}²+bZ _{q̅}³, it follows that the solution of Y²=X_{q}³+aX_{q}Z_{q}²+bZ_{q}³, denoted as (X_{q},Y,Z_{q}) has an isomorphic solution that satisfies g³Y²=X _{q̅}³+aX _{q̅}Z _{q̅}²+bZ _{q̅}³, denoted as

$$( {gX}_{q} , {g}^{\frac{3}{2}} Y , {gZ}_{q} ) .$$

(X_{q},Y,Z_{q}) leads to the elliptic curve in projective coordinates. Similarly,

$$( {gX}_{q} , {g}^{\frac{3}{2}} Y , {gZ}_{q} )$$

leads to its twist in projective coordinates. This proves the above theorem.

An example of a mapping of the solutions of Y²=X_{q}³+aX_{q}Z_{q}²+bZ_{q}³ defined over F(p), where p=3 mod 4, to the solutions of its twist is implemented by using −X for the X-coordinate, −Z for the Z-coordinate and, thus, −Y² for the Y-coordinate.

From the above proof, the following corollary is easily seen. If a twist is isomorphic to its corresponding elliptic curve, the order of the two curves is the same. A second, related theorem is given as follows: The number of points that satisfy an elliptic curve equation in projective coordinates Y²=X³+aXZ²+bZ³, defined over a finite field F(p), is 2(p²−1). This is easily proved as follows: It is well know that the number of points that satisfy an elliptic curve equation in affine coordinates y²=x³+ax+b, defined over a finite field F(p), is p+1+α, where |α|<2\sqrt{p}, while the number of points that satisfy its corresponding twist is p+1−α. The elliptic curve equation in projective coordinates Y²=X³+aXZ²+bZ³ includes both the points that satisfy the original curve in affine coordinates and its twist. This is due to the effect of the Z-coordinate. Thus, for every value of the Z-coordinate, there are p+1+α+p+1−α=2p+2 points. There are p−1 possible values of Z, thus the total number of points that satisfy the equation Y²=X³+aXZ²+bZ³ is 2(p+1)(p−1)=2(p²−1). This proves the above.

The present method of performing RSA-analogous XZ-elliptic curve cryptography is based upon the Demytko scheme. In the following, Eₚ(a,b) represents the curve of Y²=X³+aXZ²+bZ³ over finite field F(p), and Ēₚ(a,b) represents the twist of the same curve. From the above corollary, #Eₚ(a,b)=#Ēₚ(a,b), where # denotes the order of the group. The method of performing RSA-analogous XZ-elliptic curve cryptography includes the following steps.

The receiving correspondent generates its public key by the following steps: (a) choosing two substantially large prime numbers p and q and two values gᵤ and gᵥ, where gᵤ is the non-residue of p and gᵥ is the non-residue of q; (b) choosing a and b such that gcd(4a³+27b²,pq)=1; (c) computing the following values:
Nₚ, which is the order of Y²=X³+aXZ²+bZ³ over the finite field F(p),
Nₜₚ, which is the order of gᵤY²=X³+aXZ²+bZ³ over the finite field F(p),
N_{q}, which is the order of Y²=X³+aXZ²bZ³ over the finite field F(q), and
N_{tq}, which is the order of gᵥY²=X³+aXZ²+bZ³ over the finite field F(q), where Nₚ=Nₜₚ and N_{q}=N_{tq};
   (d) choosing a scalar e such that gcd(e,Nₚ)=gcd(e,N_{q})=1; (e) generating a secret key d as ed=1 mod lcm(Nₚ,N_{q}); and (f) publishing a public key (n,e,a,b).

Encryption is performed by the sending correspondent by the following steps: (g) embedding the message data string to be encrypted into an elliptic curve message point (Xₘ,Yₘ,Zₘ); (h) computing a multiplication of the scalar e with the message point (Xₘ,Yₘ,Zₘ) to obtain a cipher point (X_{c},Y_{c},Z_{c}) as (X_{c},Y_{c},Z_{c})=e(Xₘ,Yₘ,Zₘ); and (i) sending the X-coordinate and the Z-coordinate of the cipher point (X_{c},Y_{c},Z_{c}) to the receiving correspondent.

Decryption is then performed by the receiving correspondent by the following steps: (j) computing a multiplication of the scalar secret key d with the cipher point (X_{c},Y_{c},Z_{c}) to obtain the message point (Xₘ,Zₘ,Zₘ) as (Xₘ,Yₘ,Zₘ)=d(X_{c},Y_{c},Z_{c}); and (k) recovering the message data string from the message point (Xₘ,Yₘ,Zₘ).

It should be noted that in XZ-elliptic curve cryptography, the recovering correspondent has only one private, or secret, key d, while in the case of the conventional Demytko scheme, a correspondent must have four different private keys. Additionally, in XZ-elliptic curve cryptography, the condition on the public key e is less restrictive and is simpler in that the public key must satisfy gcd(e,Nₚ)=gcd(e,N_{q})=1, compared to the conditions used in the Demytko scheme, where it must satisfy gcd(e,N₁)=gcd(e,N₂)=gcd(e,N₃)=gcd(e,N₄)=1.

It should be further noted that the number of bits that can be encrypted in RSA-analogous XZ-elliptic curve cryptography is proportional to the number of points that satisfy the elliptic curve equation Y²=X³+aXZ²+bZ³ defined over F(p,q), which is equal to lcm(Nₚ,N_{q}) and which, in turn, is proportional to 4(p²−1)(q²−1)˜n². In comparison, the number of bits that can be encrypted using conventional RSA cryptosystems is proportional to n.

The various known schemes used for digital signatures that are based on the representation of the elliptic curve points in affine coordinates can be adopted for EC³ digital signatures as well. This can be achieved either directly, or with some modifications that exploit the X-coordinate and the Z-coordinate of an elliptic curve point when represented in projective coordinates in generating a digital signature.

A conventional elliptic curve digital signature can be basically summarized as follows. The entity that generates a signature has a private key k_{Pr} and a public key (x_{Pu},y_{Pu})=k_{Pr}(x_{B},y_{B}). Given a message M, the entity generating the signature performs the following steps: (a) selecting a random integer k, mod p; (b) computing (x₁,y₁)=k (x_{B},y_{B}) and converting x₁ to an integer r mod p; (c) computing a message digest digest(M), which is a bit string that is dependent upon the message, and converting the bit string into an integer e; (d) computing s=k⁻¹(e+k_{Pr}r)mod p; and (e) generating the signature of the message M as (r,s). The signature is then verified at the receiving entity using the following steps: (f) computing a message digest digest(M) and converting the bit string into an integer e; (g) computing u₁=es⁻¹ mod p and u₂=rs⁻¹ mod p; (h) computing (x₂,y₂)=u₁(x_{B},y_{B})+u₂(x_{Pu},y_{Pu}) and converting x₂ into an integer v mod p; and (i) accepting the signature if v=r.

Using X- and Z-coordinates for generating a digital signature, the above elliptic curve digital signature can be modified as follows. The entity that generates a signature has a private key k_{Pr} and a public key (X_{Pu},Y_{Pu},Z_{Pu})=k_{Pr}(X_{B},Y_{B},Z_{B}). Given a message M, the entity generating the signature performs the following steps: (a) selecting a random integer k, wherein the random integer k is modulo p, wherein p is a selected integer; (b) computing (X₁,Y₁,Z₁)=k(X_{B},Y_{B},Z_{B}); (c) concatenating bit strings of X₁ and Z₁ together to form a single string [X₁:Z₁]; (d) converting the single string [X₁:Z₁] into an integer r mod p; (e) computing a message digest digest(M), which is a bit string that is dependent upon the message, and converting the bit string into an integer e; (f) computing s=k⁻¹(e+k_{Pr}r)mod p; and (g) generating the signature of the message M as (r,s). The signature is then verified at the receiving entity using the following steps: (h) computing a message digest digest(M) and converting the bit string into an integer e; (i) computing u₁=es⁻¹ mod p and u₂=rs⁻¹ mod p; (j) computing (X₂,Y₂,Z₂)=u₁(X_{B},Y_{B},Z_{B})+u₂(X_{Pu},Y_{Pu},Z_{Pu}); (k) concatenating bit strings of X₂ and Z₂ together to form a single string [X₂:Z₂]; (l) converting the single string [X₂:Z₂] into an integer v mod p; and (m) accepting the signature if v=r.

In the method of performing RSA-analogous XZ-elliptic curve cryptography, the steps of embedding include the following steps: (a) defining the respective message bit string as an M-bit string, where M is an integer such that (2N−L)>M>(2N−L), L is an integer, N represents a number of bits used to represent F(p) elements, and F(p) represents a finite field containing the elliptic curve set EC³, where p represents a set of points on EC³; (b) dividing the respective message bit string into two strings m₁ and m₂, where the length of string m₁ is less than or equal to (N−L) bits and the length of string m₂ is less than or equal to (N−1) bits; (c) assigning the value of the bit string m₂ to Rₘ; (d) using a Legendre test to determine if Rₘ has a square root, and then, if Rₘ has a square root, setting Zₘ=Rₘ and if Rₘ does not have a square root, then setting Zₘ=gRₘ, where g is non-quadratic residue in F(p); (e) computing aZₘ² and bZₘ³, where a and b are selected scalars; (f) assigning the value of the bit string m₁ to Xₘ; (g) computing a value T as T=Xₘ³+(aZₘ²)Xₘ+(bZₘ³) and using a Legendre test to determine if T has a square root; and (h) assigning the square root of T to Yₘ if T has a square root, and incrementally increasing Xₘ and returning to step (g) if T does not have a square root.

In the above, it should be noted that p is usually predetermined prior to encryption. Thus, the value of g can also be predetermined. When using the embedding method given above, the strings m₁ and m₂ can be recovered directly from Xₘ and Zₘ, respectively. An extra bit is needed to identify whether Rₘ or gRₘ is used for Zₘ at the receiver. Therefore, to encode (N−1) message data bits, one needs to send N bits for the Z values.

Any non-quadratic value in F(p) can be used for g. For efficiency, g is chosen to be −1 for p≡3 mod 4 or when p≡1 mod 4.

At the receiver, the process is reversed. In the case of g=2, a division by 2 is carried out. It should noted that dividing Rₘ by two is computed using one modulo addition, since: (i) Rₘ/2=((Rₘ−(Rₘ)mod 2)/2)+(Rₘ)mod 2*(½)mod p; (ii) (Rₘ)mod 2 is the least significant bit of Rₘ; and (iii) (½)mod p=(p+1)/2.

The security of the password protocols depends on the security of the underlying elliptic polynomial cryptography. The security of elliptic polynomial cryptosystems is assessed by both the effect on the solution of the elliptic curve discrete logarithmic problem (ECDLP) and power analysis attacks.

For the same underlying finite field, both RSA cryptosystems and RSA-analogous XZ-elliptic curve cryptosystems are based on an identical factorization problem, thus they offer the same level of security. RSA-analogous XZ-elliptic curve cryptography also requires the computation of scalar multiplication. At the sending correspondent, RSA-analogous elliptic curve cryptography does not offer any weakness against power attacks, since the scalar multiplication performed by the sending correspondent involves a public key which does not need to be protected. This is another advantage of RSA-analogous XZ-elliptic curve cryptography over elliptic curve cryptography based on the discrete logarithm problem.

It should be understood that the calculations may be performed by any suitable computer system, such as that diagrammatically shown in the sole drawing FIGURE. Data is entered into system 100 via any suitable type of user interface 116, and may be stored in memory 112, which may be any suitable type of computer readable and programmable memory. Calculations are performed by processor 114, which may be any suitable type of computer processor and may be displayed to the user on display 118, which may be any suitable type of computer display.

Processor 114 may be associated with, or incorporated into, any suitable type of computing device, for example, a personal computer or a programmable logic controller. The display 118, the processor 114, the memory 112 and any associated computer readable recording media are in communication with one another by any suitable type of data bus, as is well known in the art.

Examples of computer-readable recording media include a magnetic recording apparatus, an optical disk, a magneto-optical disk, and/or a semiconductor memory (for example, RAM, ROM, etc.). Examples of magnetic recording apparatus that may be used in addition to memory 112, or in place of memory 112, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

It is to be understood that the present invention is not limited to the embodiments described above, but encompasses any and all embodiments within the scope of the following claims.

We claim:

1. A computerized method of performing RSA-analogous XZ-elliptic curve cryptography, comprising the steps of:
(a) selecting a pair of substantially large prime numbers p and q, and selecting a pair of values gᵤ and gᵥ, wherein gᵤ is non-residue of p and gᵥ is non-residue of q;
(b) selecting a pair of scalars a and b such that gcd(4a³+27b²,pq)=1;
(c) calculating an order Nₚ of an elliptic curve Y²=X³+aXZ²+bZ³ over a finite field F(p), wherein X, Y and Z are orthogonal Cartesian coordinates;
(d) calculating an order Nₜₚ of a curve gᵤY²=X³+aXZ²+bZ³ over the finite field F(p);
(e) calculating an order N_{q} of the elliptic curve Y²=X³+aXZ²+bZ³ over the finite field F(q);
(f) calculating an order N_{tq} of a curve gᵥY²=X³+aXZ²+bZ³ over the finite field F(q);
(g) selecting a scalar e such that gcd(e,Nₚ)=gcd(e,N_{q})=1;
(h) generating a secret key d as
$$d = \frac{1 mod 1 cm ( {N}_{p} , {N}_{q} )}{e} \text{;}$$
(i) publishing a public key (n,e,a,b), wherein n=pq;
(j) embedding a message data string to be encrypted into an elliptic curve message point (Xₘ,Yₘ,Zₘ);
(k) multiplying the scalar e and the message point (Xₘ,Yₘ,Zₘ) to obtain a cipher point (X_{c},Y_{c},Z_{c}) as (X_{c},Y_{c},Z_{c})=e(Xₘ,Yₘ,Zₘ);
(l) multiplying the scalar secret key d and the cipher point (X_{c},Y_{c},Z_{c}) to obtain the message point (Xₘ,Yₘ,Zₘ) as (Xₘ,Yₘ,Zₘ)=d (X_{c},Y_{c},Z_{c}); and
(m) recovering the message data string from the message point (Xₘ,Yₘ,Zₘ).

2. The computerized method of performing RSA-analogous XZ-elliptic curve cryptography as recited in claim 1, wherein Nₚ=Nₜₚ and N_{q}=N_{tq}.

3. The computerized method of performing RSA-analogous XZ-elliptic curve cryptography as recited in claim 2, wherein a receiving correspondent generates and publishes the public key in steps (a) through (i).

4. The computerized method of performing RSA-analogous XZ-elliptic curve cryptography as recited in claim 3, wherein a sending correspondent performs encryption of the message data string in steps (j) and (k).

5. The computerized method of performing RSA-analogous XZ-elliptic curve cryptography as recited in claim 4, wherein following step (k), the sending correspondent sends the X-coordinate and the Z-coordinate of the cipher point (X_{c},Y_{c},Z_{c}) to the receiving correspondent.

6. The computerized method of performing RSA-analogous XZ-elliptic curve cryptography as recited in claim 5, wherein the receiving correspondent performs decryption of the message data string in steps (l) and (m).

7. The computerized method of performing RSA-analogous XZ-elliptic curve cryptography as recited in claim 6, wherein the step of embedding includes the steps of:
(a) defining the message data string as an M-bit string, wherein M is an integer such that (2N−L)>M>(2N−L), where L is an integer, and N represents a number of bits used to represent the elements of F(p);
(b) dividing the message bit string into two strings m₁ and m₂, wherein the length of string m₁ is less than or equal to (N−L) bits and the length of string m₂ is less than or equal to (N−1) bits;
(c) assigning the value of the bit string m₂ to a variable Rₘ;
(d) using a Legendre test to determine if Rₘ has a square root, and if Rₘ has a square root, setting a variable Zₘ equal to Rₘ, and if Rₘ does not have a square root, then setting Zₘ=gRₘ, where g is non-quadratic residue in F(p);
(e) computing aZₘ² and bZₘ³, where a and b are selected scalars;
(f) assigning the value of the bit string m₁ to Xₘ;
(g) computing a value T as T=Xₘ³+(aZₘ²)Xₘ+(bZₘ³) and using a Legendre test to determine if T has a square root; and
(h) assigning the square root of T to Yₘ if T has a square root, and incrementally increasing Xₘ and returning to step (g) if T does not have a square root.

8. A system for performing RSA-analogous XZ-elliptic curve cryptography, comprising:
a processor;
computer readable memory coupled to the processor;
a user interface coupled to the processor;
a display coupled to the processor;
software stored in the memory and executable by the processor, the software having:
means for selecting a pair of substantially large prime numbers p and q, and selecting a pair of values gᵤ and gᵥ, wherein gᵤ is non-residue of p and gᵥ is non-residue of q;
means for selecting a pair of scalars a and b such that gcd(4a³+27b², pq)=1;
means for calculating an order Nₚ of an elliptic curve Y²=X³+aXZ²+bZ³ over a finite field F(p), wherein X, Y and Z are orthogonal Cartesian coordinates;
means for calculating an order Nₜₚ of a curve gᵤY²=X³+aXZ²+bZ³ over the finite field F(p);
means for calculating an order N_{q} of the elliptic curve Y²=X³+aXZ²+bZ³ over the finite field F(q);
means for calculating an order N_{tq} of a curve gᵥY²=X³+aXZ²+bZ³ over the finite field F(q);
means for selecting a scalar e such that gcd(e,Nₚ)=gcd(e,N_{q})=1;
means for generating a secret key d as
$$d = \frac{1 mod 1 cm ( {N}_{p} , {N}_{q} )}{e} \text{;}$$
means for publishing a public key (n,e,a,b), wherein n=pq;
means for embedding a message data string to be encrypted into an elliptic curve message point (Xₘ,Yₘ,Zₘ);
means for computing a multiplication of the scalar e with the message point (Xₘ,Yₘ,Zₘ) to obtain a cipher point (X_{c},Y_{c},Z_{c}) as (X_{c},Y_{c},Z_{c})=e(Xₘ,Yₘ,Zₘ);
means for computing a multiplication of the scalar secret key d with the cipher point (X_{c},Y_{c},Z_{c}) to obtain the message point (Xₘ,Yₘ,Zₘ) as (Xₘ,Yₘ,Zₘ)=d(X_{c},Y_{c},Z_{c}); and
means for recovering the message data string from the message point (Xₘ,Yₘ,Zₘ).

9. The system for performing RSA-analogous XZ-elliptic curve cryptography as recited in claim 8, wherein Nₚ=Nₜₚ and N_{q}=N_{tq}.

10. A computer software product that includes a medium readable by a processor, the medium having stored thereon a set of instructions for performing RSA-analogous XZ-elliptic curve cryptography, the instructions comprising:
(a) a first sequence of instructions which, when executed by the processor, causes the processor to select a pair of substantially large prime numbers p and q, and selecting a pair of values gᵤ and gᵥ, wherein gᵤ is non-residue of p and gᵥ is non-residue of q;
(b) a second sequence of instructions which, when executed by the processor, causes the processor to select a pair of scalars a and b such that gcd(4a³+27b²,pq)=1;
(c) a third sequence of instructions which, when executed by the processor, causes the processor to calculate an order Nₚ of an elliptic curve Y²=X³+aXZ²+bZ³ over a finite field F(p), wherein X, Y and Z are orthogonal Cartesian coordinates;
(d) a fourth sequence of instructions which, when executed by the processor, causes the processor to calculate an order Nₜₚ of a curve gᵤY²=X³+aXZ²+bZ³ over the finite field F(p);
(e) a fifth sequence of instructions which, when executed by the processor, causes the processor to calculate an order N_{q} of the elliptic curve Y²=X³+aXZ²+bZ³ over the finite field F(q);
(f) a sixth sequence of instructions which, when executed by the processor, causes the processor to calculate an order N_{tq} of a curve gᵥY²=X³+aXZ²+bZ³ over the finite field F(q);
(g) a seventh sequence of instructions which, when executed by the processor, causes the processor to select a scalar e such that gcd(e,Nₚ)=gcd(e,N_{q})=1;
(h) an eighth sequence of instructions which, when executed by the processor, causes the processor to generate a secret key d as
$$d = \frac{1 mod 1 cm ( {N}_{p} , {N}_{q} )}{e} \text{;}$$
(i) a ninth sequence of instructions which, when executed by the processor, causes the processor to publish a public key (n,e,a,b), wherein n=pq;
(j) a tenth sequence of instructions which, when executed by the processor, causes the processor to embed a message data string to be encrypted into an elliptic curve message point (Xₘ,Yₘ,Zₘ);
(k) an eleventh sequence of instructions which, when executed by the processor, causes the processor to compute a multiplication of the scalar e with the message point (Xₘ,Yₘ,Zₘ) to obtain a cipher point (X_{c},Y_{c},Z_{c}) as (X_{c},Y_{c},Z_{c})=e(Xₘ,Yₘ,Zₘ);
(l) a twelfth sequence of instructions which, when executed by the processor, causes the processor to compute a multiplication of the scalar secret key d with the cipher point (X_{c},Y_{c},Z_{c}) to obtain the message point (Xₘ,Yₘ,Zₘ) as (Xₘ,Yₘ,Zₘ)=d(X_{c},Y_{c},Z_{c}); and
(m) a thirteenth sequence of instructions which, when executed by the processor, causes the processor to recover the message data string from the message point (Xₘ,Yₘ,Zₘ).
